(19) United States
(12) Patent Application Publication
(10) Pub. No.: US 2017/0357666 A1
(43) Pub. Date: Dec. 14, 2017

(54) IMPLEMENTING QUEUES (FIFO) AND STACKS (FILO) ON TOP DISPERSED STORAGE

(71) Applicant: International Business Machines Corporation, Armonk, NY (US)

(72) Inventors: Andrew D. Baptist, Mt. Pleasant, WI (US); Wesley B. Leggette, Chicago, IL (US); Jason K. Resch, Chicago, IL (US)

(21) Appl. No.: 15/670,900

(22) Filed: Aug. 7, 2017

Related U.S. Application Data
(63) Continuation-in-part of application No. 14/055,174, filed on Oct. 16, 2013.
(60) Provisional application No. 61/733,686, filed on Dec. 5, 2012.

(51) Int. Cl. G06F 17/30; H04L 29/08; H04L 29/12; G06F 11/07; G06F 11/10; H04L 29/06

(52) U.S. Cl. CPC G06F 17/30194; G06F 11/0727; G06F 11/1092; G06F 11/0793; H04L 67/1034; H04L 29/12009; H04L 67/1008; H04L 2029/06054; G06F 2211/1038

(57) ABSTRACT

A computing device includes an interface to communicate with a dispersed storage network (DSN), a memory, and a processing module. The computing device receives, from another computing device, a write queue entry request to facilitate storage of one or more queue entries of a queue in a set of storage units (SUs). The computing device dispersed error encodes at least a portion of the write queue entry request to generate a set of queue entry encoded slices (QEESs). The computing device generates a write request, based on the write queue entry request, that includes a slice name corresponding to a QEES of the set of QEESs that includes a queue entry identifier (ID) field that includes a timestamp field and/or an entry number of the write queue entry request. The computing device transmits the write request to the set of SUs to facilitate distributed storage of the set of QEESs.

### CROSS REFERENCE TO RELATED PATENTS

The present U.S. Utility Patent Application claims priority pursuant to 35 U. S.C. §120, as a continuation-in-part (CIP) of U.S. utility patent application Ser. No. 14/055,174, entitled “ACCESSING DISTRIBUTED COMPUTING FUNCTIONS IN A DISTRIBUTED COMPUTING SYSTEM,” filed Oct. 16, 2013, pending, which claims priority pursuant to 35 U.S.C. §119(e) to U.S. Provisional Application No. 61/733,686, entitled “GENERATING A DISPERSED QUEUE,” filed Dec. 5, 2012, both of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

Technical Field of the Invention

This invention relates generally to computer networks and more particularly to dispersing error encoded data.

Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

The prior art provides no adequate or acceptable means by which queues and stacks may be implemented and serviced in conjunction with prior art data storage systems. There exists in a need in the art for improved and better means by which queues and stacks may be implemented and serviced in accordance with data storage systems.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of another embodiment of a dispersed or distributed storage network (DSN) in accordance with the present invention;

FIG. 10A is a flowchart illustrating an example of storing a queue entry in accordance with the present invention; and

FIG. 10B is a diagram illustrating an embodiment of a method for execution by one or more computing devices in accordance with the present invention.

### DETAILED DESCRIPTION OF THE INVENTION

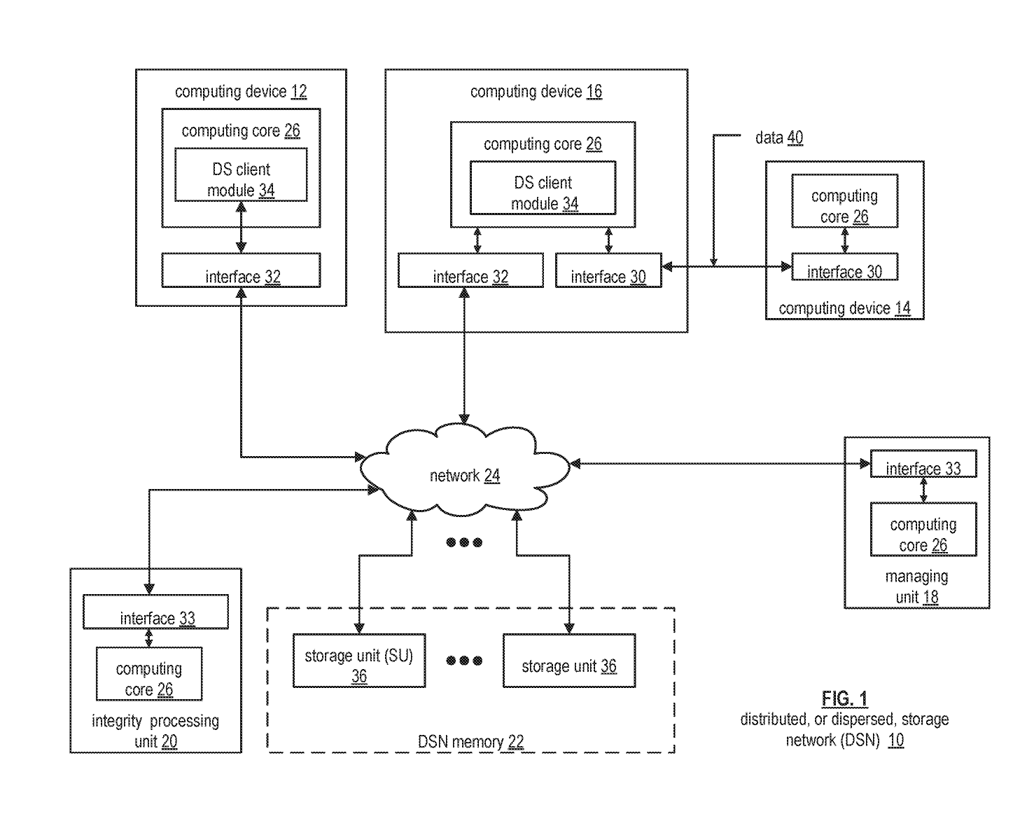

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

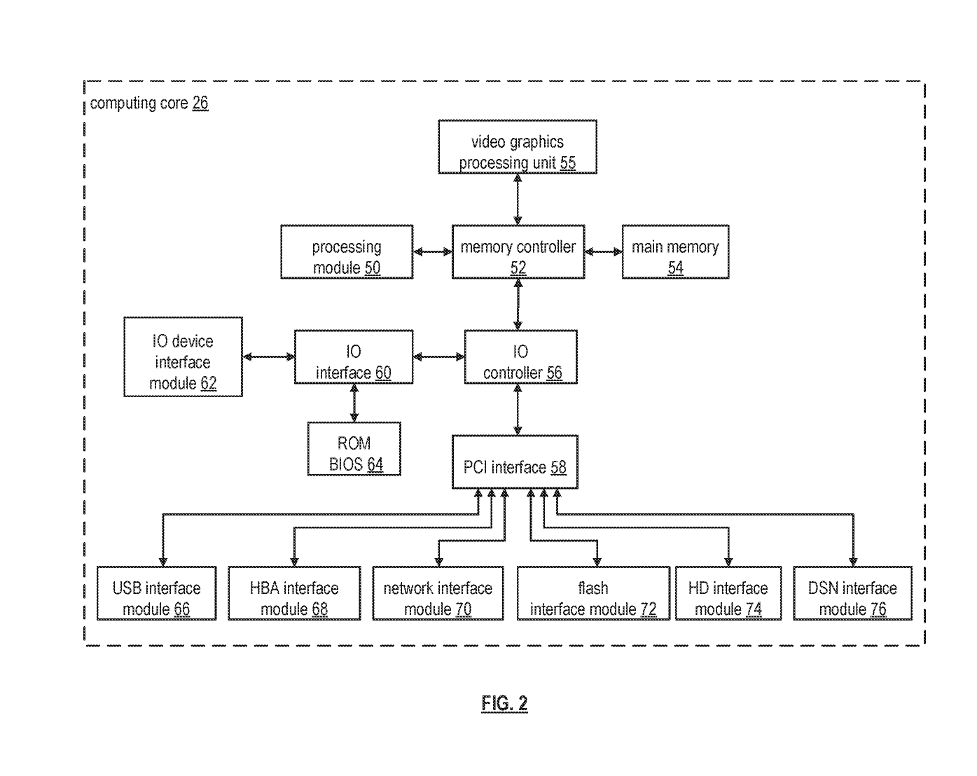

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

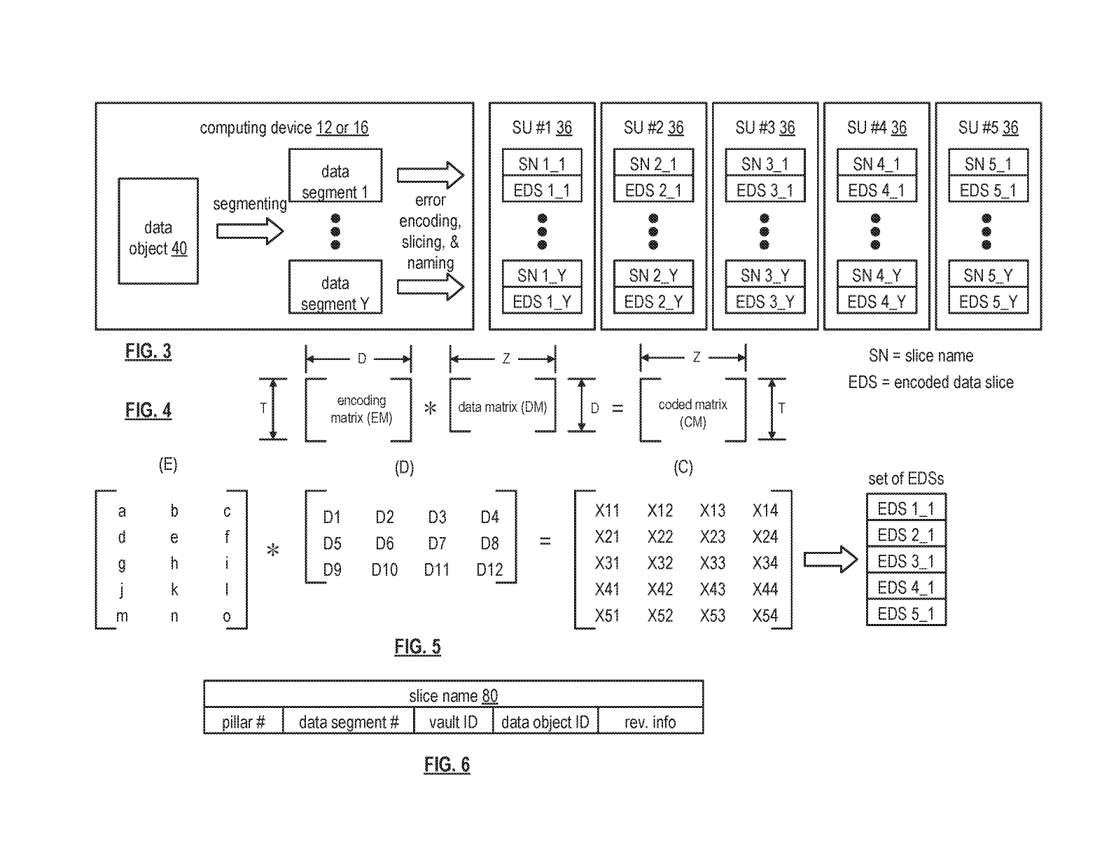

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN module 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (10) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

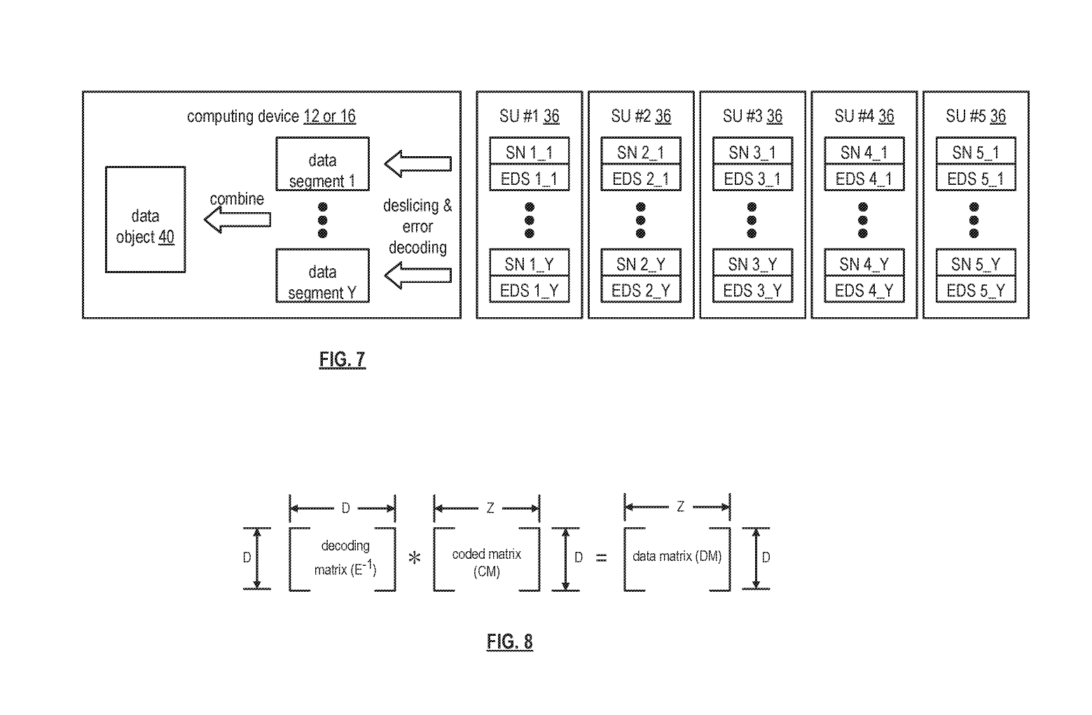

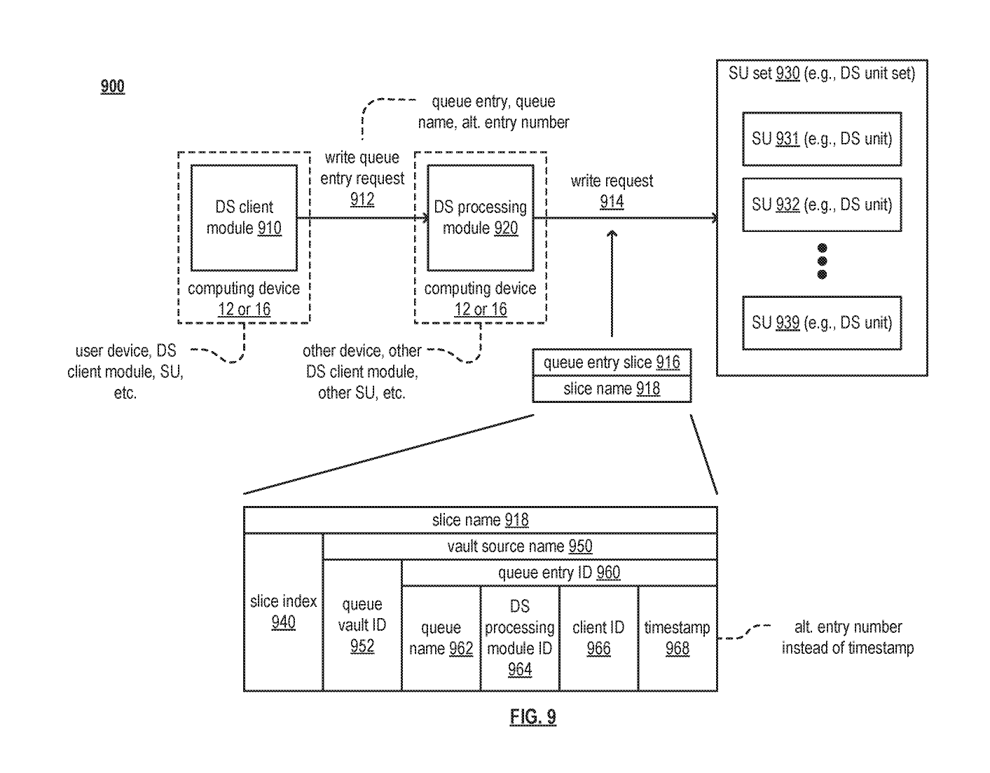

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

In some examples, note that dispersed or distributed storage network (DSN) memory includes one or more of a plurality of storage units (SUs) such as SUs 36 (e.g., that may alternatively be referred to a distributed storage and/or task network (DSTN) module that includes a plurality of distributed storage and/or task (DST) execution units 36 that may be located at geographically different sites (e.g., one in Chicago, one in Milwaukee, etc.). Each of the SUs (e.g., alternatively referred to as DST execution units in some examples) is operable to store dispersed error encoded data and/or to execute, in a distributed manner, one or more tasks on data. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, etc.

FIG. 9 is a schematic block diagram of another embodiment of a dispersed storage system that includes a DS client module 910 (e.g., that may be implemented as an instantiation of the computing device 12 or 16), a dispersed storage (DS) processing module 920 (e.g., that may be implemented as another instantiation of the computing device 12 or 16), and a storage unit (SU) set 930 (e.g., a DS unit set). The SU set 930 includes a set of storage units (SUs) 931, 932, and up to 939 (e.g., a set of DS units). The DS client module 910 may be implemented utilizing at least one of a user device, a computing device, a DS client module, a storage unit (SU), a distributed storage and task (DST) client module, a DST processing unit, a DST execution unit, and/or a DS processing unit. The DS processing module 920 may be implemented utilizing at least one of a DS client module, a DST client module, a DST processing unit, a DS processing unit, a user device, a computing device, a DST execution unit, a SU, and/or a DS unit. The system is operable to facilitate storage of one or more queue entries of a queue in the SU set 930.

The DS client module 910 generates a write queue entry request 912 where the write queue entry request 912 includes one or more of a queue entry, a queue name, and an entry number. The DS client module 910 may utilize the entry number to facilitate ordering of two or more queue entries. The DS client module 910 outputs the write queue entry request 912 to the DS processing module 920. The DS processing module 920 encodes the queue entry using a dispersed storage error coding function to produce a set of queue entry slices. For each SU of the SU set 930, the DS processing module 920 generates a write request 914 and outputs the write request 914 to the SU to facilitate storage of the queue entry slices by the SU set 930.

The write request 914 includes one or more of a queue entry slice 916 of the set of queue entry slices and/or a slice name 918 corresponding to the queue entry slice. The generating includes generating the slice name 918 based on the write queue entry request 912. The slice name 918 includes a slice index field 940 and a vault source name field 950. The slice index field 940 includes a slice index entry that corresponds to a pillar number of a set of pillar numbers associated with a pillar width dispersal parameter utilized in the dispersed storage error coding function. The vault source name field 950 includes a queue vault identifier (ID) field 952 and a queue entry ID field 960. The queue vault ID field 952 includes an identifier of a vault of the dispersed storage system associated with the queue. The DS processing module 920 generates a queue vault ID entry for the queue vault ID field 952 by a one or more of a dispersed storage network registry lookup based on an identifier of a requesting entity associated with the write queue entry request 912, receiving the queue vault ID, and generating a new queue vault ID when a new queue name is requested (e.g., not previously utilized in the dispersed storage network).

The queue entry ID field 960 includes a queue name field 962, a DS processing module ID field 064, a client ID field 966, and a timestamp field 968. The DS processing module 920 generates a queue name entry for the queue name field based on the queue name of the write queue entry request 912. The DS processing module 920 generates a DS processing module ID entry for the DS processing module ID field as an identifier associated with the DS processing module 920 by at least one of a lookup, receiving, and generating when and ID has not been assigned so far. The DS processing module 920 generates a client ID entry for the client ID field as an identifier associated with the DS client module 910 (e.g., the requesting entity) by at least one of a lookup, extracting from the write queue entry request 912, initiating a query, and receiving. The DS processing module 920 generates a timestamp entry for the timestamp field 968 as at least one of a current timestamp, the entry number of the write queue entry request 912 (e.g., when provided), and a combination of the current timestamp and the entry number. In an implementation example, the slice name is 48 bytes, the queue entry ID field is 24 bytes, the queue name field is 8 bytes, the DS processing module ID is 4 bytes, the client ID field is 4 bytes, and the timestamp field is 8 bytes.

In some examples, a computing device that includes the DS client module 34 is implemented to include an interface configured to interface and communicate with a dispersed or distributed storage network (DSN), a memory that stores operational instructions, and a processing module operably coupled to the interface and to the memory, wherein the processing module, when operable within the computing device based on the operational instructions, is configured to perform various operations and functions.

In an example of operation and implementation, a computing device is configured to receive, from another computing device, a write queue entry request to facilitate storage of one or more queue entries of a queue in a set of storage units (SUs). The computing device is also configured to dispersed error encode, based on a dispersed error coding function, at least a portion of the write queue entry request to generate a set of queue entry encoded slices (QEESs). Note that the at least the portion of the write queue entry request is segmented into a plurality of data segments, and a data segment of the plurality of data segments is dispersed error encoded in accordance with dispersed error encoding parameters to produce the set of QEESs. Also, the computing device is configured to generate a write request based on the write queue entry request. In some examples, the write request includes a slice name corresponding to a QEES of the set of QEESs. Also, in some examples, the slice name includes a queue entry identifier (ID) field that includes at least one of a timestamp field or an entry number of the write queue entry request. The computing device is configured to transmit the write request to the set of SUs to facilitate distributed storage of the set of QEESs among the set of SUs.

In some examples, the write queue entry request includes at least one of a queue entry, a queue name, and an entry number. Also, in certain examples, the write request includes the QEES of the set of QEESs and the slice name corresponding to the QEES of the set of QEESs.

In other examples, the slice name includes a slice index field and a vault source name field, and the slice index field includes a slice index entry that corresponds to a pillar number of a set of pillar numbers associated with a pillar width dispersal parameter based on the dispersed error coding function. Also, the vault source name field includes a queue vault identifier (ID) field and the queue entry ID field, and the queue vault ID field includes an identifier of a vault of the DSN associated with the queue.

In some examples, the computing device is also configured to generate a queue vault ID entry for the queue vault ID field based on at least one of a dispersed storage network registry lookup based on an identifier (ID) of a requesting entity associated with the write entry request, receiving the queue vault ID entry, or generating a new queue vault ID entry based on request of a new name for the queue.

In some examples, the queue entry ID field includes a queue name field, a distributed storage (DS) module field corresponding to the computing device, a client ID field corresponding to the other computing device, and the timestamp field.

In some examples, note that a decode threshold number of EDSs are needed to recover the data segment, and a read threshold number of EDSs provides for reconstruction of the data segment. The set of EDSs is of pillar width and includes a pillar number of EDSs, and each of the decode threshold, the read threshold, and the write threshold is less than the pillar number. Also, in some examples, the write threshold number is greater than or equal to the read threshold number that is greater than or equal to the decode threshold number.

The computing device may be implemented as any of a number of different devices including a managing unit that is remotely located from the other computing device within the DSN and also remotely located from at least one SU of the plurality of SUs within the DSN. In other examples, the computing device may be implemented as a SU of the plurality of SUs within the DSN, a wireless smart phone, a laptop, a tablet, a personal computers (PC), a work station, or a video game device. Also, the DSN may be implemented to include or be based on any of a number of different types of communication systems including a wireless communication system, a wire lined communication systems, a non-public intranet system, a public internet system, a local area network (LAN), and/or a wide area network (WAN).

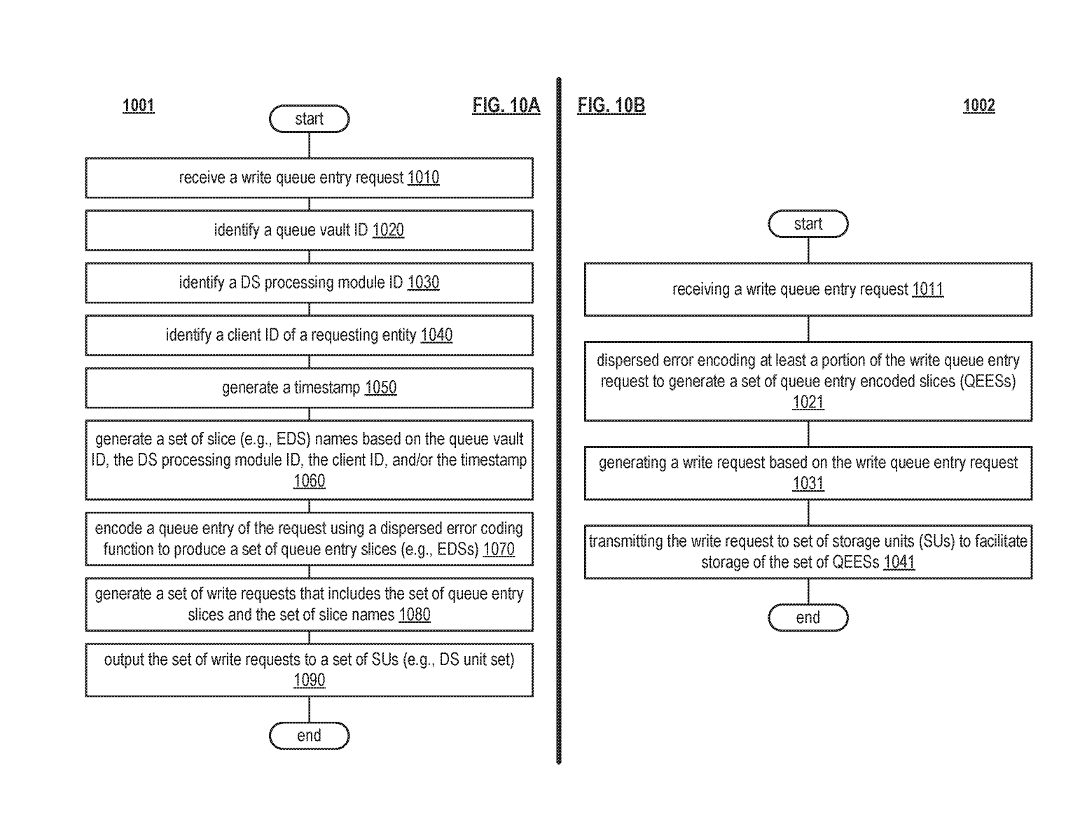

FIG. 10A is a flowchart illustrating an example of storing a queue entry. The method 1001 begins at the step 1010 where a processing module (e.g., of a dispersed storage (DS) processing module) receives a write queue entry request. The request includes one or more of a requesting entity identifier (ID), a queue entry, a queue name, and an entry number. The method 1001 continues at the step 1020 where the processing module identifies a queue vault ID. The identifying may be based on one or more of the requesting entity ID, the queue name, and a look up. For example, the processing module accesses a queue directory utilizing the queue name to identify vault ID.

The method 1001 continues at the step 1030 where the processing module identifies a DS processing module ID associated with processing of the write queue entry request. The identifying may be based on one or more of generating a new ID, extracting from the request, a lookup, initiating a query, and receiving the identifier. The method 1001 continues at the step 1040 where the processing module identifies a client ID associated with the requesting entity. The identifying may be based on one or more of extracting from the request, a lookup, initiating a query, and receiving the identifier.

The method 1001 continues at the step 1050 of the processing module generates a timestamp. The generating includes at least one of obtaining a real-time time value and utilizing the entry number of the write queue entry request when provided. The method 1001 continues at step 1060 where the processing module generates a set of slice names based on one or more of a dispersed queue slice name structure, queue vault ID, the DS processing module ID, the client ID, and the timestamp. For example, the processing module generates a slice name of the set of slice names to include a slice index corresponding to a slice to be associated with the slice name, the queue vault ID, the queue name of the write queue entry request, the DS processing module ID, the client ID, and the timestamp as described with reference to FIG. 9.

The method 1001 continues at the step 1070 where the processing module encodes the queue entry of the write queue entry request using a dispersed storage error coding function to produce a set of queue entry slices. The method 1001 continues at the step 1080 where the processing module generates a set of write requests that includes the set of queue entry slices and the set of slice names. The method 1001 continues at the step 1090 where the processing module outputs the set of write requests to a set of SUs to facilitate storage of the set of queue entry slices.

FIG. 10B is a diagram illustrating an embodiment of a method 1002 for execution by one or more computing devices in accordance with the present invention. The method 1002 begins in step 1011 by receiving, via an interface of the computing device that is configured to interface and communicate with a dispersed or distributed storage network (DSN) and from another computing device, a write queue entry request to facilitate storage of one or more queue entries of a queue in a set of storage units (SUs).

The method 1002 continues in step 1021 by dispersed error encoding, based on a dispersed error coding function, at least a portion of the write queue entry request to generate a set of queue entry encoded slices (QEESs), wherein the at least the portion of the write queue entry request is segmented into a plurality of data segments, wherein a data segment of the plurality of data segments is dispersed error encoded in accordance with dispersed error encoding parameters to produce the set of QEESs.

The method 1002 then operates in step 1031 by generating a write request based on the write queue entry request, wherein the write request includes a slice name corresponding to a QEES of the set of QEESs, and wherein the slice name includes a queue entry identifier (ID) field that includes at least one of a timestamp field or an entry number of the write queue entry request. The method 1002 continues in step 1041 by transmitting, via the interface of the computing device, the write request to the set of SUs to facilitate distributed storage of the set of QEESs among the set of SUs.

In some examples, the write queue entry request includes at least one of a queue entry, a queue name, and an entry number. Also, in some examples, the write request includes the QEES of the set of QEESs and the slice name corresponding to the QEES of the set of QEESs.

In some particular examples, the slice name includes a slice index field and a vault source name field, and the slice index field includes a slice index entry that corresponds to a pillar number of a set of pillar numbers associated with a pillar width dispersal parameter based on the dispersed error coding function. Also, the vault source name field includes a queue vault identifier (ID) field and the queue entry ID field, and the queue vault ID field includes an identifier of a vault of the DSN associated with the queue.

In some variant examples of the method 1002, the method 1002 operates by generating a queue vault ID entry for the queue vault ID field based on at least one of a dispersed storage network registry lookup based on an identifier (ID) of a requesting entity associated with the write entry request, receiving the queue vault ID entry, or generating a new queue vault ID entry based on request of a new name for the queue.

In some examples, note that the queue entry ID field includes a queue name field, a distributed storage (DS) module field corresponding to the computing device, a client ID field corresponding to the other computing device, and the timestamp field.

In some examples, note that a decode threshold number of EDSs are needed to recover the data segment, and a read threshold number of EDSs provides for reconstruction of the data segment. The set of EDSs is of pillar width and includes a pillar number of EDSs, and each of the decode threshold, the read threshold, and the write threshold is less than the pillar number. Also, in some examples, the write threshold number is greater than or equal to the read threshold number that is greater than or equal to the decode threshold number.

Note that such a computing device performing the method may be implemented and located at a first premises that is remotely located from at least one SU of the plurality of SUs within the DSN. Also, note that such a DSN may include a wireless communication system, a wire lined communication systems, a non-public intranet system, a public internet system, a local area network (LAN), and/or a wide area network (WAN).

This disclosure presents, among other things, various examples of operations that may be performed by an appropriately configured computing device. One example includes a computing device (e.g., a DS processing unit) that is configured to interact with a dispersed or distributed storage network (DSN) memory that includes a number of storage units (SUs).

Considering some example, queues are data structures which implement a strict ordering. For example, the order in which objects are written to the queue will be the same order that they are read from the queue (First in first out, or FIFO). A variation on this is the first in last out (FILO) queue (alternatively known as a stack). To provide a highly reliable, and shared queue, one is implemented on top of dispersed storage as follows:

A computing device (e.g., a client) sends a request to another computing device (e.g., a DS processing unit) to write a queue entry to a queue (for a given queue vault). The request may contain a queue name, and a client generated number (if it wants to enforce ordering of its writes). The other computing device then forms an object ID using the queue name, an accesser-generated-ID, the requestor ID, a timestamp, and a number (if provided). These attributes together compose a queue entry ID. Due to the nature of the incorporation of the timestamp, a property of the queue entry IDs is that they are always ascending. Therefore, when listing forwards against the vault from the first position in the vault's namespace range, one will see the names of queue entries in the order they were written, and a reverse ordering can be found by listing backwards from the last name in the vault's namespace range. If the client-provided queue name is the prefix for the listing, then a particular queue can be listed, and multiple queues can exist within the same vault.

Consider an example queue entry ID (192 bits): 64 bits queue name, 32 bits accesser id, 32 bits client id, 64 bits (timestamp or client generated number).

The content of the queue entry is then dispersed and/or dispersed error encoded and written to the dispersed storage, treating the queue entry ID as the object's vault-specific source name (the last 24 bytes of the slice name).

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A computing device comprising:
an interface configured to interface and communicate with a dispersed or distributed storage network (DSN);
memory that stores operational instructions; and
a processing module operably coupled to the interface and to the memory, wherein the processing module, when operable within the computing device based on the operational instructions, is configured to:
receive, from another computing device, a write queue entry request to facilitate storage of one or more queue entries of a queue in a set of storage units (SUs);
dispersed error encode, based on a dispersed error coding function, at least a portion of the write queue entry request to generate a set of queue entry encoded slices (QEESs), wherein the at least the portion of the write queue entry request is segmented into a plurality of data segments, wherein a data segment of the plurality of data segments is dispersed error encoded in accordance with dispersed error encoding parameters to produce the set of QEESs;
generate a write request based on the write queue entry request, wherein the write request includes a slice name corresponding to a QEES of the set of QEESs, and wherein the slice name includes a queue entry identifier (ID) field that includes at least one of a timestamp field or an entry number of the write queue entry request; and
transmit the write request to the set of SUs to facilitate distributed storage of the set of QEESs among the set of SUs.

2. The computing device of claim 1, wherein:
the write queue entry request includes at least one of a queue entry, a queue name, and an entry number; and
the write request includes the QEES of the set of QEESs and the slice name corresponding to the QEES of the set of QEESs.

3. The computing device of claim 1, wherein:
the slice name includes a slice index field and a vault source name field;
the slice index field includes a slice index entry that corresponds to a pillar number of a set of pillar numbers associated with a pillar width dispersal parameter based on the dispersed error coding function;
the vault source name field includes a queue vault identifier (ID) field and the queue entry ID field; and
the queue vault ID field includes an identifier of a vault of the DSN associated with the queue.

4. The computing device of claim 3, wherein the processing module, when operable within the computing device based on the operational instructions, is further configured to:
generate a queue vault ID entry for the queue vault ID field based on at least one of a dispersed storage network registry lookup based on an identifier (ID) of a requesting entity associated with the write entry request, receiving the queue vault ID entry, or generating a new queue vault ID entry based on request of a new name for the queue.

5. The computing device of claim 1, wherein the queue entry ID field includes:
a queue name field, a distributed storage (DS) module field corresponding to the computing device, a client ID field corresponding to the another computing device, and the timestamp field.

6. The computing device of claim 1, wherein the computing device is located at a first premises that is remotely located from at least one SU of the set of SUs within the DSN.

7. The computing device of claim 1 further comprising:
a SU of the set of SUs within the DSN, a wireless smart phone, a laptop, a tablet, a personal computers (PC), a work station, or a video game device.

8. The computing device of claim 1, wherein the DSN includes at least one of a wireless communication system, a wire lined communication systems, a non-public intranet system, a public internet system, a local area network (LAN), or a wide area network (WAN).

9. A computing device comprising:
an interface configured to interface and communicate with a dispersed or distributed storage network (DSN);
memory that stores operational instructions; and
a processing module operably coupled to the interface and to the memory, wherein the processing module, when operable within the computing device based on the operational instructions, is configured to:
receive, from another computing device, a write queue entry request to facilitate storage of one or more queue entries of a queue in a set of storage units (SUs), wherein the write queue entry request includes at least one of a queue entry, a queue name, and an entry number;
dispersed error encode, based on a dispersed error coding function, at least a portion of the write queue entry request to generate a set of queue entry encoded slices (QEESs), wherein the at least the portion of the write queue entry request is segmented into a plurality of data segments, wherein a data segment of the plurality of data segments is dispersed error encoded in accordance with dispersed error encoding parameters to produce the set of QEESs;
generate a write request based on the write queue entry request, wherein the write request includes a slice name corresponding to a QEES of the set of QEESs and the QEES of the set of QEESs, and wherein the slice name includes a queue entry identifier (ID) field that includes a queue name field, a distributed storage (DS) module field corresponding to the computing device, a client ID field corresponding to the another computing device, and least one of a timestamp field or the entry number of the write queue entry request; and
transmit the write request to the set of SUs to facilitate distributed storage of the set of QEESs among the set of SUs.

10. The computing device of claim 9, wherein:
the slice name includes a slice index field and a vault source name field;
the slice index field includes a slice index entry that corresponds to a pillar number of a set of pillar numbers associated with a pillar width dispersal parameter based on the dispersed error coding function; the vault source name field includes a queue vault identifier (ID) field and the queue entry ID field; and
the queue vault ID field includes an identifier of a vault of the DSN associated with the queue.

11. The computing device of claim 10, wherein the processing module, when operable within the computing device based on the operational instructions, is further configured to:
generate a queue vault ID entry for the queue vault ID field based on at least one of a dispersed storage network registry lookup based on an identifier (ID) of a requesting entity associated with the write entry request, receiving the queue vault ID entry, or generating a new queue vault ID entry based on request of a new name for the queue.

12. The computing device of claim 9 further comprising:
a SU of the set of SUs within the DSN, a wireless smart phone, a laptop, a tablet, a personal computers (PC), a work station, or a video game device.

13. The computing device of claim 9, wherein the DSN includes at least one of a wireless communication system, a wire lined communication systems, a non-public intranet system, a public internet system, a local area network (LAN), or a wide area network (WAN).

14. A method for execution by a computing device, the method comprising:
receiving, via an interface of the computing device that is configured to interface and communicate with a dispersed or distributed storage network (DSN) and from another computing device, a write queue entry request to facilitate storage of one or more queue entries of a queue in a set of storage units (SUs);
dispersed error encoding, based on a dispersed error coding function, at least a portion of the write queue entry request to generate a set of queue entry encoded slices (QEESs), wherein the at least the portion of the write queue entry request is segmented into a plurality of data segments, wherein a data segment of the plurality of data segments is dispersed error encoded in accordance with dispersed error encoding parameters to produce the set of QEESs;
generating a write request based on the write queue entry request, wherein the write request includes a slice name corresponding to a QEES of the set of QEESs, and wherein the slice name includes a queue entry identifier (ID) field that includes at least one of a timestamp field or an entry number of the write queue entry request; and
transmitting, via the interface of the computing device, the write request to the set of SUs to facilitate distributed storage of the set of QEESs among the set of SUs.

15. The method of claim 14, wherein:
the write queue entry request includes at least one of a queue entry, a queue name, and an entry number; and
the write request includes the QEES of the set of QEESs and the slice name corresponding to the QEES of the set of QEESs.

16. The method of claim 14, wherein:
the slice name includes a slice index field and a vault source name field;
the slice index field includes a slice index entry that corresponds to a pillar number of a set of pillar numbers associated with a pillar width dispersal parameter based on the dispersed error coding function;
the vault source name field includes a queue vault identifier (ID) field and the queue entry ID field; and
the queue vault ID field includes an identifier of a vault of the DSN associated with the queue.

17. The method of claim 16 further comprising:
generating a queue vault ID entry for the queue vault ID field based on at least one of a dispersed storage network registry lookup based on an identifier (ID) of a requesting entity associated with the write entry request, receiving the queue vault ID entry, or generating a new queue vault ID entry based on request of a new name for the queue.

18. The method of claim 14, wherein the queue entry ID field includes:
a queue name field, a distributed storage (DS) module field corresponding to the computing device, a client ID field corresponding to the another computing device, and the timestamp field.

19. The method of claim 14, wherein the computing device includes a SU of the set of SUs within the DSN, a wireless smart phone, a laptop, a tablet, a personal computers (PC), a work station, or a video game device.

20. The method of claim 14, wherein the DSN includes at least one of a wireless communication system, a wire lined communication systems, a non-public intranet system, a public internet system, a local area network (LAN), or a wide area network (WAN).
